(19) United States
(12) Patent Application Publication
(10) Pub. No.: US 2024/0322921 A1
(43) Pub. Date: Sep. 26, 2024

(54) USER DEVICE FOR MEASURING NARROWBAND REFERENCE SIGNAL RECEIVED POWER AND OPERATING METHOD THEREOF

(71) Applicant: Samsung Electronics Co., Ltd., Suwon-si (KR)

(72) Inventors: Gunyoung KO, Suwon-si (KR); Dahae CHONG, Suwon-si (KR); Beomkon KIM, Suwon-si (KR); Joohyun DO, Suwon-si (KR); Myungjoon SHIM, Suwon-si (KR); Yujin SIM, Suwon-si (KR)

(73) Assignee: Samsung Electronics Co., Ltd., Suwon-si (KR)

(21) Appl. No.: 18/610,785

(22) Filed: Mar. 20, 2024

(30) Foreign Application Priority Data
Mar. 21, 2023 (KR) 10-2023-0036890
Aug. 22, 2023 (KR) 10-2023-0110128

(51) Int. Cl. H04B 17/318; H04W 24/08

(52) U.S. Cl. CPC H04B 17/328; H04W 24/08

(57) ABSTRACT

A user device for performing narrowband Internet of Things-based communication, the user device including processing circuitry configured to descramble narrowband physical broadcast channels (NPBCHs) respectively included in at least two frames to obtain at least two descrambled NPBCHs, the NPBCHs including identical data and having different phases from each other, and measure narrowband reference signal received power (NRSRP) based on the at least two descrambled NPBCHs.

### CROSS-REFERENCE TO RELATED APPLICATION

This application is based on and claims priority under 35 U.S.C. § 119 to Korean Patent Application No. 10-2023-0036890, filed on Mar. 21, 2023, and Korean Patent Application No. 10-2023-0110128, filed on Aug. 22, 2023, in the Korean Intellectual Property Office, the disclosures of each of which are incorporated by reference herein in their entireties.

### BACKGROUND

The inventive concepts relate to an electronic device, and more particularly, to a user device for measuring narrowband reference signal received power (NRSRP) and an operating method of the user device.

Low-power long-distance communication technology is used in the field of Internet of Things and meets the conditions for low power consumption, low-cost devices, low construction costs, stable coverage, and large-scale device access. A representative example of low-power and long-distance communication technology is the narrowband Internet of Things communication technology that may provide stable communication services by utilizing the known long term evolution (LTE) network and without building a separate network for the Internet of Things. In addition, the narrowband Internet of Things communication technology supports narrowband communication, and thus, it may also be used for satellite communication that uses low-power and long-distance communication.

In addition, in order to perform a handover function in the narrowband Internet of Things, a user device may periodically measure received power (reference signal received power (NRSRP)) of a signal received from a currently connected serving cell and a nearby neighboring cell. In this case, in order for a user device to measure NRSRP using the received narrowband physical broadcast channel (NPBCH), successful decoding of the NPBCH is first performed. That is, in order to measure NRSRP by using an NPBCH, a user device stores the decoded NPBCH in a memory and regenerates an NPBCH through a process of encoding, scrambling, and modulating the NPBCH according to a decoding rule. Then, NRSRP is measured by using the regenerated NPBCH, and thus, a considerable amount of time is expended to measure the NRSRP.

### SUMMARY

Embodiments provide a method that reduces the time spent to measure the NRSRP by measuring the NRSRP without decoding. The inventive concepts provide a user device capable of measuring NRSRP by descrambling a narrowband physical broadcast channel without decoding the narrowband physical broadcast channel, and an operating method of the user device. In particular, the inventive concepts provide a user device capable of measuring reference signal received power based on at least two narrowband physical broadcast channels received by each of different consecutive frames without decoding the narrowband physical broadcast channel and including identical data (or similar data) with different phases, and an operating method of the user device.

According to an aspect of the inventive concepts, a user device, that performs narrowband Internet of Things-based communication, includes processing circuitry configured to descramble narrowband physical broadcast channels (NPBCHs) respectively included in at least two frames to obtain at least two descrambled NPBCHs, the NPBCHs including identical data and having different phases from each other, and measure narrowband reference signal received power (NRSRP) based on the at least two descrambled NPBCHs.

According to an aspect of the inventive concepts, an operating method of a user device that performs narrowband Internet of Things-based communication includes extracting narrowband physical broadcast channels (NPBCHs) from at least two frames to obtain extracted NPBCHs, the NPBCHs including identical data and having different phases from each other, generating at least two descrambled NPBCHs by descrambling the extracted NPBCHs, and measuring narrowband reference signal received power (NRSRP) based on the at least two descrambled NPBCHs.

According to an aspect of the inventive concepts, a user device, that performs narrowband Internet of Things-based communication, includes processing circuitry configured to measure first narrowband reference signal received power (NRSRP) based on at least two first narrowband physical broadcast channels (NPBCHs), the at least two first NPBCHs being included in each of at least two frames among at least N consecutive frames received from a first cell, N being an integer of 2 or greater, the first cell being connected to the user device, and the at least two first NPBCHs including identical data and having different phases from each other, measure a second NRSRP based on at least two second NPBCHs included in each of at least two frames among at least N consecutive frames received from a second cell, the second cell being different from the first cell, and the at least two second NPBCHs including identical data and having different phases from each other, and determine whether to request a handover based on the first NRSRP and the second NRSRP.

### BRIEF DESCRIPTION OF THE DRAWINGS

Embodiments of the inventive concepts will be more clearly understood from the following detailed description taken in conjunction with the accompanying drawings in which:

FIG. 1 illustrates a wireless communication system according to embodiments;

FIG. 2 is a block diagram illustrating an implementation example of a user device, according to embodiments;

FIG. 3 is a diagram illustrating a basic structure of a time-frequency domain that is a radio resource region of a wireless communication system;

FIG. 4 is a diagram illustrating frames received by a user device, according to embodiments;

FIG. 5 is a diagram illustrating subframes received by a user device, according to embodiments;

FIG. 6 is a diagram illustrating a structure of a time-frequency domain of a first subframe received by a user device, according to embodiments;

FIG. 7 is a flowchart illustrating an operating method of a user device, according to embodiments;

FIG. 8 is a flowchart illustrating an operating method of a user device according to embodiments;

FIG. 9 is a flowchart illustrating an operating method of a user device according to embodiments;

FIG. 10 is a flowchart illustrating an operating method of a user device according to embodiments;

FIG. 11 is a schematic block diagram illustrating an electronic device according to embodiments; and

FIG. 12 is a conceptual diagram illustrating an Internet of Things (IoT) network system to which embodiments of the inventive concepts are applied.

### DETAILED DESCRIPTION

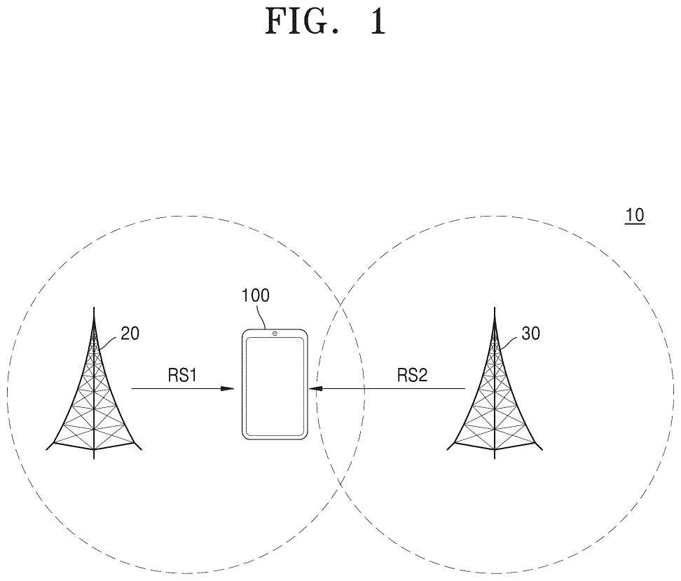

FIG. 1 illustrates a wireless communication system according to embodiments.

Hereinafter, embodiments are described with respect to a wireless communication system 10 for narrowband Internet of Things-based communication, but the inventive concepts are not limited to the narrowband Internet of Things-based communication. Specifically, the inventive concepts may be applied to various types of lower-power longer-distance communication with a similar technical background or channel setting. Furthermore, the inventive concepts may also be applied to other wireless communication systems (for example, a cellular communication system, such as a wireless broadband (WiBro), a global system for mobile communication (GSM), fifth generation (5G), or sixth generation (6G), a short-distance communication system, such as Bluetooth or near field communication (NFC), or so on).

Also, various functions to be described below may be implemented or supported by artificial intelligence technology or one or more computer programs, each of which is composed of computer-readable program codes and implemented on a computer-readable medium. The terms “application” and “program” refer to one or more computer programs, software components, sets of instructions, procedures, functions, objects, classes, instances, associated data, or portions thereof suitable for implementation in suitable computer-readable program codes. The term “computer-readable program code” includes all types of computer code, including source code, object code, and executable code. The term “computer-readable media” includes all types of media that may be accessed by a computer, such as read only memory (ROM), random access memory (RAM), a hard disk drive, a compact disk (CD), a digital video disk (DVD), or any other type of memory. “Non-transitory” computer-readable media excludes wired, wireless, optical, or other communication links that transmit transient electrical or other signals. Non-transitory computer-readable media includes media on which data may be permanently stored, and media on which data may be stored and overwritten later, such as rewritable optical disks or erasable memory devices.

Embodiments below describe a hardware approaching method as an example. However, embodiments include technology using both hardware and software, and accordingly, embodiments do not exclude a software-based approaching method.

Referring to FIG. 1, the wireless communication system 10 may include a serving cell 20, a user device 100, and/or a neighboring cell 30.

The serving cell 20 is a network infrastructure that provides wireless access to the user device 100. The serving cell 20 and the neighboring cell 30 may each have a coverage defined as a certain geographic area based on a distance over which signals may be transmitted. The serving cell 20 and the neighboring cell 30 may each be referred to as a node B, a base station, an evolved-node B (eNB), a next generation node B (gNB), a sector, a site, a base transceiver system (BTS), an access point (AP), a relay node, a remote radio head (RRH), a radio unit (RU), a small cell, a wireless device, or so on.

The user device 100 is used by a user and may communicate with the serving cell 20 through a wireless channel. In addition to a terminal, the user device 100 may be replaced with an electronic device, a mobile station, a subscriber station, a customer premises equipment (CPE), a remote terminal, a wireless terminal, a user device, or another term having equivalent technical meaning.

The serving cell 20 may refer to a cell that currently performs wireless communication with the user device 100, and the neighboring cell 30 may refer to a cell adjacent to the user device 100 excluding the serving cell 20 (e.g., other than the serving cell 20).

Referring to FIG. 1, the serving cell 20 may broadcast a first broadcast information signal RS1, and the neighboring cell 30 may broadcast a second broadcast information signal RS2. The first broadcast information signal (RS1) may include a signal for synchronizing the user device 100 with the serving cell 20.

The user device 100 may receive broadcast information signals from the serving cell 20 and the neighboring cell 30. For example, the user device 100 may receive the first broadcast information signal RS1 from the serving cell 20 and the second broadcast information signal RS2 from the neighboring cell 30. The user device 100 may receive the first broadcast information signal RS1 and the second broadcast information signal RS2, and request the serving cell 20 for a handover based on the received power of the received signals (e.g., based on a first NRSRP of the first broadcast information signal RS1 and a second NRSRP of the second broadcast information signal RS2). For example, when moving in the direction towards where the neighboring cell 30 is located, the user device 100 may determine that connecting to the neighboring cell 30 is better for signal quality. Accordingly, the user device 100 may request the serving cell 20 for a handover to the neighboring cell 30 when the received power of the second broadcast information signal RS2 (e.g., the second NRSRP) is greater than the received power of the first broadcast information signal RS1 (e.g., the first NRSRP). Also, the user device 100 may perform a cell re-selection operation to maintain connection to the serving cell 20 based on the received power of the first broadcast information signal RS1 (e.g., the first NRSRP). According to embodiments, for example, the user device 100 may perform the cell re-selection operation in response to determining that the first NRSRP does not exceed a threshold value. According to embodiments, the user device 100 may only measure the first NRSRP of the first broadcast information signal RS1, without measuring the second NRSRP of the broadcast information signal RS2, until the user device 100 determines that the first NRSRP is equal to or less than the threshold value at which point the user device 100 may measure the second NRSRP of the second broadcast information signal RS2 and request the serving cell 20 for the handover to the neighboring cell 30 in response to determining the second NRSRP is greater than the first NRSRP. According to embodiments, the user device 100 may measure each of the first NRSRP and the second NRSRP according to any of the examples discussed herein.

The user device 100 according to the inventive concepts does not presuppose successful decoding of narrowband physical broadcast channel (NPBCH) to measure narrowband reference signal received power (NRSRP) based on the NPBCH included in each of the first broadcast information signal RS1 and the second broadcast information signal RS2. Accordingly, the user device 100 may measure the NRSRP based on the NPBCH included in each of the first broadcast information signal RS1 and the second broadcast information signal RS2 (e.g., without decoding the NPBCH).

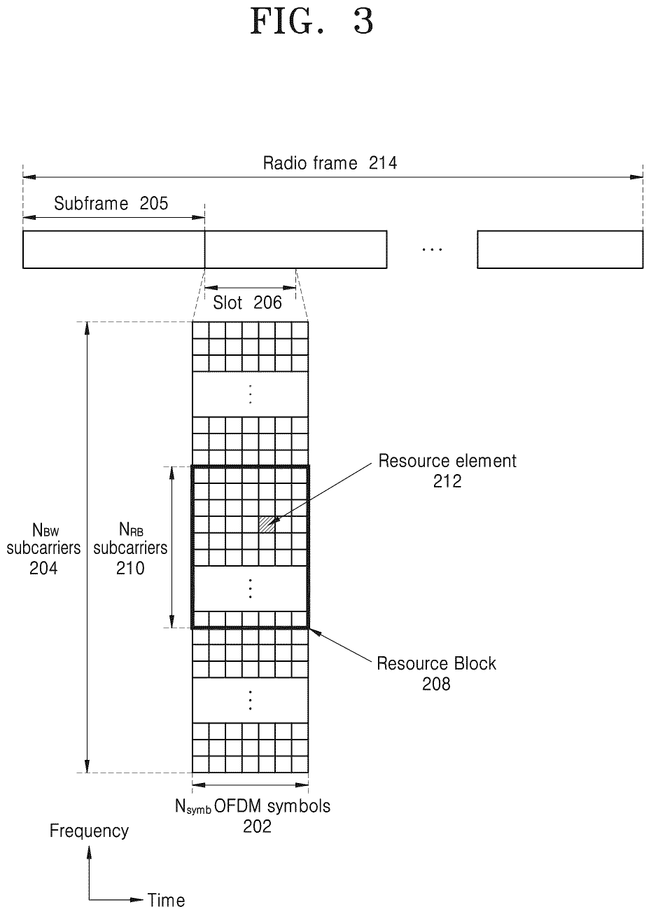

The NPBCH that the user device 100 receives from each of the serving cell 20 and the neighboring cell 30 is a general physical channel through which channel-coded information is transmitted and may include essential system information called a master information block (MIB). The MIB may include remaining system information for the user device 100. For example, the MIB may include information on a system frame number, an operating mode, scheduling information of a subsequent system information block (SIB), and so on. The serving cell 20 and the neighboring cell 30 may repeatedly transmit an NPBCH over up to 8 frames to the user device 100 to improve a coverage. The NPBCHs repeatedly received by the user device 100 may respectively include identical data (or similar data) with different phases according to a scrambling sequence. One frame may include one NPBCH. For example, each of the first broadcast information signal RS1 and the second broadcast information signal RS2 may include eight consecutive frames on a time axis, and the eight frames may respectively include NPBCHs including identical data (or similar data) with different phases from each other. Descriptions of a frame structure and data included in the NPBCH are given below with reference to FIGS. 3 to 6.

The user device 100 according to the inventive concepts may descramble an NPBCH included in each of at least two consecutive frames and then measure NRSRP based on the at least two descrambled NPBCHs. The NRSRP may refer to the received power of a broadcast information signal. Specifically, the user device 100 may measure NRSRP (hereinafter, first NRSRP) based on the first broadcast information signal RS1 received from the serving cell 20 and measure NPSRP (hereinafter, referred to as second NRSRP) based on the second broadcast information signal RS2 received from the neighboring cell 30. The user device 100 may request handover to the serving cell 20 by comparing the first NRSRP with the second NRSRP. Also, the user device 100 may maintain a connection with the serving cell 20 based on the first NRSRP.

The user device 100 according to the inventive concepts may measure the NRSRP without decoding the NPBCH by utilizing repetitive characteristics of the NPBCH included in the received broadcast information signal. Accordingly, the user device 100 may measure a second NRSRP for not only the first broadcast information signal RS1 received from the serving cell 20, but also the second broadcast information signal RS2 received from the neighboring cell 30. In addition, the time consumed to measure NRSRP may be reduced by omitting decoding of an NPBCH to measure the NRSRP.

In the above description, for the sake of convenience of description, only the measurement of NRSRP is described based on the first broadcast information signal RS1 and the second broadcast information signal RS2 received from the serving cell 20 and the neighboring cell 30, respectively. However, the inventive concepts are not limited thereto, and NRSRP of each of broadcast information signals received from one or more neighboring cells may be measured based on broadcast information signals respectively received from the one or more neighboring cells.

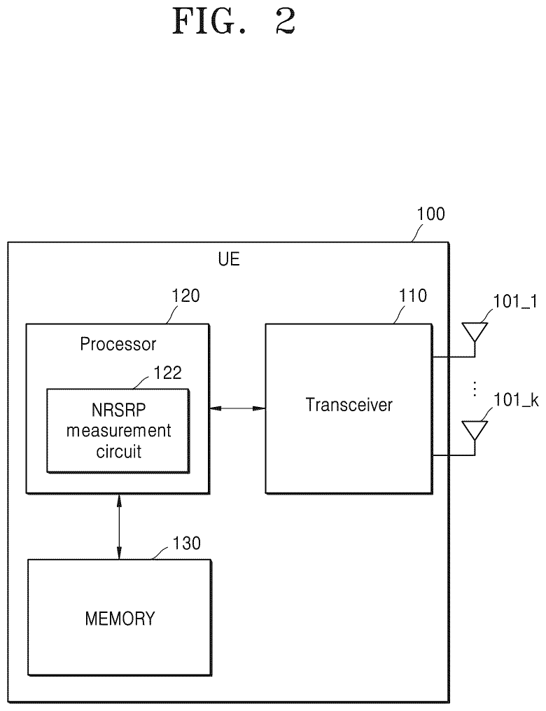

FIG. 2 is a block diagram illustrating an implementation example of a user device, according to embodiments.

A user device 100 in FIG. 2 corresponds to the user device 100 in FIG. 1, and thus, redundant descriptions thereof are omitted.

Referring to FIG. 2, the user device 100 may include a plurality of antennas 101_1 to 101_k, a transceiver 110, a processor 120, and/or a memory 130. The processor 120 may include an NRSRP measurement circuit 122.

The transceiver 110 may receive a downlink signal transmitted by a cell through the plurality of antennas 101_1 to 101_k. The transceiver 110 may down-convert the frequency of a received downlink signal to generate an intermediate frequency or baseband signal(s). The processor 120 may generate data signals by filtering, decoding, and digitizing the intermediate frequency or baseband signal(s). The processor 120 may perform a preset (or alternatively, given) operation based on the data signals.

Also, the processor 120 may encode, multiplex, and analogize (e.g., digital-to analog convert) the data signals generated by the preset (or alternatively, given) operation (or another operation). The transceiver 110 may up-convert an intermediate frequency or baseband signals output from the processor 120 and transmit the up-converted signal as uplink signals through the plurality of antennas 101_1 to 101_k. However, this is only an example, and the user device 100 may further include an additional integrated circuit (not illustrated) configured to perform some of the operations of the processor 120 described above without being limited thereto.

The processor 120 according to the inventive concepts may include the NRSRP measurement circuit 122. The NRSRP measurement circuit 122 may measure NRSRP based on an NPBCH included in the downlink signal (e.g., the broadcast information signal) received by the transceiver 110. The NRSRP measurement circuit 122 may descramble at least two NPBCHs included in the broadcast information signal to generate at least two descrambled NPBCHs, and calculate NRSRP based on the at least two descrambled NPBCHs.

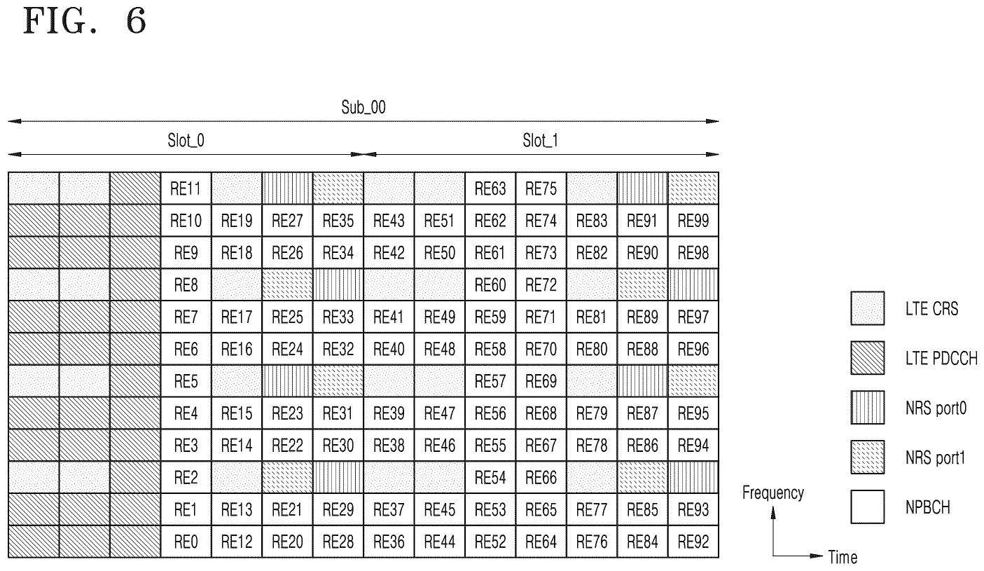

Specifically, the NRSRP measurement circuit 122 according to embodiments may generate an average value of the received powers (hereinafter, referred to as an average value) of resource elements (REs) by summing (for example, sum of received power corresponding to RE) the received powers of REs that are included in each of at least two descrambled NPBCHs and correspond to each other. The NRSRP measurement circuit 122 may calculate mean square of average values. Alternatively, the NRSRP measurement circuit 122 may calculate an average of absolute values of the average values. In the inventive concepts, mean square of average values and an average of absolute values of average values may each be referred to as the magnitude of average values. Accordingly, the NRSRP measurement circuit 122 may measure NRSRP based on summation of received powers of corresponding REs. Details thereof are given below with reference to FIGS. 3 and 6. In the inventive concepts, the received power of an RE refers to the received power of a received signal transmitted by using the RE.

An NRSRP measurement circuit 122 according to embodiments may generate a differential correlation value by differentially correlating the received powers of REs that are included in each of two consecutive descrambled NPBCHs and correspond to each other. The NRSRP measurement circuit 122 may measure the NRSRP based on the differential correlation value. Specifically, the NRSRP measurement circuit 122 may measure the NRSRP based on a plurality of differential correlation values. For example, the NRSRP measurement circuit 122 may measure the NRSRP based on an average of the plurality of differential correlation values. Details of NRSRP measurement based on differential correlation values are given below with reference to FIG. 6.

A user device 100 according to embodiments may receive a first frame group including at least two frames and a second frame group including at least two frames different from the at least two frames included in the first frame group. In this case, frames included in the first frame group and the second frame group may be consecutive frames. In addition, the frames included in the first frame group and the second frame group may be all or part of eight consecutive frames. The user device 100 may descramble an NPBCH included in the first frame group to generate at least two first descrambled NPBCHs, and descramble an NPBCH included in the second frame group to generate at least two second descrambled NPBCHs. The user device 100 may measure NRSRP based on a first cumulative value corresponding to the cumulative received powers of REs that are included in each of at least two first descrambled NPBCHs and correspond to each other and a second cumulative value corresponding to the cumulative received powers of REs that are included in each of at least two second descrambled NPBCHs and correspond to each other. The user device 100 may measure NRSRP based on a differential correlation between the first cumulative value and the second cumulative value. Details of the NRSRP measurement based on the first cumulative value and the second cumulative value are given below with reference to FIG. 6.

The memory 130 may receive and store the descrambled NPBCH from the processor 120.

The memory 130 may transmit the stored descrambled NPBCH to the processor 120 in response to a request of the processor 120.

FIG. 3 is a diagram illustrating a basic structure of a time-frequency domain, which is a radio resource area of a wireless communication system.

Referring to FIG. 3, a horizontal axis may denote a time domain, and a vertical axis may denote a frequency domain. A smallest transmission unit of the time domain is an orthogonal frequency division multiplexing (OFDM) symbol, and N_{symb} OFDM symbols 202 may form one slot 206. Two slots may form one subframe 205. For example, a length of the slot 206 may be 0.5 ms, and a length of the subframe 205 may be 1.0 ms. However, this is an example, and a length of the slot 206 may vary depending on a configuration of the slot 206, and the number of slots 206 included in the subframe 205 may vary depending on a length of the slot 206. In addition, in an new radio (NR) network (e.g., 5G NR), a time-frequency domain may be defined according to the slot 206. Also, a radio frame 214 may be a unit of the time domain consisting of 10 subframes 205.

The smallest transmission unit of the frequency domain is a subcarrier, and a bandwidth of the entire system transmission band may consist of a total of N_{BW} (204) subcarriers. In the time-frequency domain, a basic unit of resource is RE 212, which may be represented as an OFDM symbol index and a subcarrier index. An RB (resource block) 208 may be defined as consecutive N_{symb} OFDM symbols 202 in the time domain and consecutive N_{RB} subcarriers 210 in the frequency domain. Accordingly, one RB 208 may be composed of (N_{symb}*N_{RB}) REs 212.

The basic structure of the time-frequency domain illustrated in FIG. 3 may be used in narrowband Internet of Things communication according to embodiments. Hereinafter, for the sake of convenience of description, it is assumed that the basic structure of the time-frequency domain described with reference to FIG. 3 is used. However, the inventive concepts are not limited thereto.

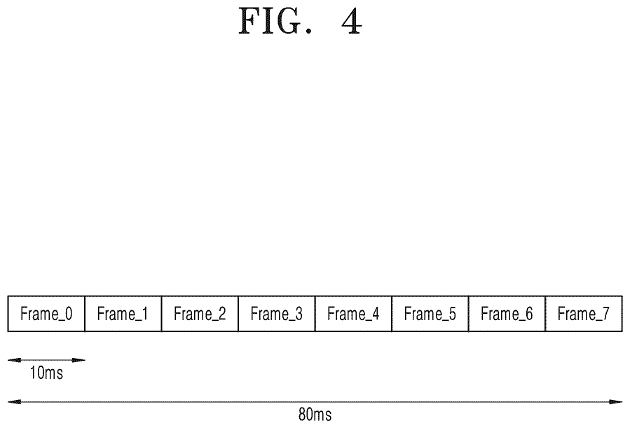

FIG. 4 is a diagram illustrating frames received by a user device, according to embodiments.

Each of the first to eighth frames (Frame_0 to Frame_7) of FIG. 4 corresponds to the radio frame 214 described with reference to FIG. 3. Therefore, redundant descriptions thereof are omitted.

Referring to FIG. 4, the user device 100 of FIG. 1 may receive eight consecutive frames, that is, the first to eighth frames Frame_0 to Frame_7, for 80 ms. As described above with reference to 3, the user device 100 of FIG. 1 may receive the first to eighth frames Frame_0 to Frame_7 one by one in units of 10 ms.

As described above, the serving cell 20 of FIG. 1 and the neighboring cell 30 of FIG. 1 may each repeatedly transmit an NPBCH (e.g., a respective NPBCH) to the user device 100 of FIG. 1 up to eight times to increase a coverage. The user device 100 of FIG. 1 may receive each of eight NPBCHs through the first to eighth frames Frame_0 to Frame_7.

Referring to FIG. 4, the user device 100 of FIG. 1 is represented as receiving eight consecutive frames. However, the user device 100 of FIG. 1 according to the inventive concepts may measure the NRSRP by utilizing characteristics of repeatedly receiving NPBCHs including identical data (or similar data). Accordingly, the user device 100 of FIG. 1 may measure the NRSRP based on at least two consecutive NPBCHs.

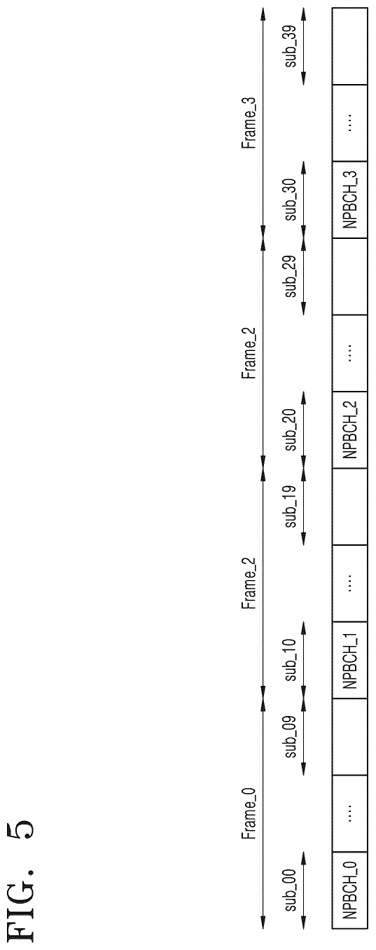

FIG. 5 is a diagram illustrating subframes received by a user device, according to embodiments.

First to fourth frames Frame_0 to Frame_3 of FIG. 5 respectively correspond to the first to fourth frames described with reference to FIG. 4, and each of subframes Sub_00 to Sub_39 corresponds to the subframe 205 of FIG. 3. Therefore, redundant descriptions thereof are omitted. Although FIG. 5 illustrates only the first to fourth frames Frame_0 to Frame_3 for the sake of convenience of description, the fifth to eighth frames Frame_4 to Frame_7 of FIG. 4 may be similarly understood through descriptions below.

Referring to FIG. 5, one frame may include 10 subframes as described above with reference to FIG. 3. For example, the first frame Frame_0 may include first to tenth subframes Sub_00 to Sub_09. Similarly, the second frame Frame_1 may include first to tenth subframes Sub_10 to Sub_19, and the third frame Frame_2 may include first to tenth subframes Sub_20 to Sub_29, and the fourth frame Frame_3 may include first to tenth subframes Sub_30 to Sub_39.

An NPBCH may be included in the first subframe among the subframes included in the frame.

For example, an NPBCH NPBCH_0 may be included in the first subframe Sub_00, which is a head subframe among 10 subframes Sub_00 to Sub_09 included in the first frame Frame_0. Similarly, an NPBCH NPBCH_1 may be included in the first subframe Sub_10, which is a head subframe among 10 subframes Sub_10 to Sub_19 included in the second frame Frame_1, an NPBCH NPBCH_2 may be included in the first subframe Sub_20, which is the first subframe among 10 subframes Sub_20 to Sub_29 included in the third frame Frame_2, an NPBCH NPBCH_3 may be included in the first subframe Sub_30, which is the first subframe among 10 subframes Sub_30 to Sub_39 included in the fourth frame Frame_3. According to embodiments, the NPBCH may be included in only the head subframe among the subframes of each frame, however, embodiments are not limited thereto.

As described above, the serving cell 20 of FIG. 1 and the neighboring cell 30 of FIG. 1 may repeatedly transmit the NPBCH to the user device 100 of FIG. 1 up to eight times to increase a coverage. The user device 100 of FIG. 1 may receive an NPBCH through the first subframe (that is, one subframe) included in a frame. Hereinafter, the user device 100 of FIG. 1 is described to receive one NPBCH through one frame, however, embodiments are not limited thereto.

In the inventive concepts, NPBCHs (for example, NPBCH_0 and NPBCH_1) respectively included in two consecutive frames (for example, Frame_0 and Frame_1) may be referred to as two consecutive NPBCHs.

Referring to the above description, NPBCHs NPBCH_0 to NPBCH_3 respectively included in the first to fourth frames Frame_0 to Frame_3 may include identical data (or similar data) with different phases according to a scrambling sequence. The user device 100 of FIG. 1 may extract at least two NPBCHs (for example, NPBCH_0 and NPBCH_1) from at least two consecutive frames (for example, Frame_0 and Frame_1), descramble the at least two NPBCHs, and generate a descrambled NPBCH. The user device 100 of FIG. 1 according to the inventive concepts may measure an NRSRP based on at least two descrambled NPBCHs.

FIG. 6 is a diagram illustrating a structure of a time-frequency domain of a first subframe received by a user device, according to embodiments.

FIG. 6 illustrates the first subframe Sub_00 included in the first frame Frame_0 of FIG. 5. The first subframe Sub_00 corresponds to the subframe 205 described with reference to FIG. 3. Therefore, redundant descriptions thereof are omitted.

Referring to FIG. 3, the first subframe Sub_00 may include two slots Slot_0 and Slot_1. The description of the first subframe Sub_00 given with reference to FIG. 6 may also be applied to a head subframe included in each of the first to eighth frames Frame_0 to Frame_7 of FIG. 4, that is, the first subframe. However, the inventive concepts are not limited thereto.

Referring to FIG. 6, the first subframe Sub_00 may include 12 REs in a frequency direction and 14 REs in a time direction. That is, the first subframe Frame_0 may include 168 REs.

Referring to FIG. 6, one square represents one RE. Each of the 168 REs may be assigned to one of a long term evolution (LTE) cell-specific reference signal (CRS), an LTE physical downlink control channel (PDCCH), a narrowband reference signal (NRS) port0, an NRS port1, and/or an NPBCH. 100 REs RE0 to RE99 may be assigned to an NPBCH. In the inventive concept, assigning 100 REs RE0 to RE99 to the NPBCH may be described to include 100 REs in the NPBCH. However, according to the inventive concepts, the number and positions of REs included in the NPBCH are not limited thereto. However, the positions of REs included in the NPBCH may be the same as (or similar to) each other in each frame. Also, in the inventive concepts, the received power of a signal corresponding to an RE is referred to as an RE for the sake of convenience.

In the inventive concepts, REs corresponding to each other refer to REs placed at the same position (e.g., time-frequency index), or similar positions, in the corresponding subframe (e.g., across different subframes). Here, the corresponding subframes may refer to subframes in the same order, or a similar order, among a plurality of subframes included in each of a plurality of frames. For example, each of the first subframe Sub_00 of FIG. 5 and the first subframe Sub_10 of FIG. 5 is a head subframe (e.g., first in order) of the ten subframes included in each of the first frame Frame_0 of FIG. 5 and the second frame Frame_1 of FIG. 5. Accordingly, the first subframe Sub_00 of FIG. 5 and the first subframe Sub_10 of FIG. 5 may be referred to as subframes corresponding to each other. In addition, the same position (or similar positions) in a subframe means that positions in the frequency-time domain are the same as (or similar to) each other.

Referring to FIGS. 5 and 6, the first subframes Sub_00, Sub_10, Sub_20, and Sub_30 respectively included in the first to fourth frames frame_0 to frame_3 of FIG. 5 may each include 100 REs included in the NPBCH. The REs included in each of the first subframes Sub_00, Sub_10, Sub_20, and Sub_30) may be assigned as illustrated in FIG. 6 (e.g., with respect to the specific positions of the REs in the frequency-time domain). Among the REs included in each of the corresponding first subframes Sub_00, Sub_10, Sub_20, and Sub_30 and among the REs included in the NPBCH, REs at the same position (or similar positions) may be referred to as corresponding REs. For example, RE5 included in the NPBCH of the first subframe Sub_00 and RE5 included in the NPBCH of each of the first subframes Sub_10, Sub_20, and Sub_30 may be referred to as corresponding REs. Accordingly, four REs may correspond to each other in the first subframes Sub_00, Sub_10, Sub_20, and Sub_30. According to embodiments, there may be four corresponding REs in each of the first subframes Sub_00, Sub_10, Sub_20, and Sub_30 with respect to each different position of the 100 REs illustrated in FIG. 6. For the sake of convenience of description, it is assumed that an RE is the RE included in an NPBCH.

The user device 100 of FIG. 1 according to embodiments may measure NRSRP based on an average value of the received powers of REs that are included in each of at least two descrambled NPBCHs and correspond to each other.

For example, the user device 100 of FIG. 1 may calculate an average value of the sum (or may be referred to as accumulation or cumulative value) of the received powers of four corresponding REs, and may measure NRSRP based on the average value. Specifically, the user device 100 of FIG. 1 may measure NRSRP based on an average value (that is, mean square of the average value or an absolute value of the average value). The user device 100 of FIG. 1 according to the inventive concepts may measure NRSRP based on a plurality of average values. For example, referring to FIGS. 5 and 6, there may be four REs corresponding to each other as described above, and the user device 100 of FIG. 1 may calculate an average value of the received powers of the four corresponding REs. According to embodiments, the user device 100 may sum the four corresponding REs and divide the result by four to obtain the average value. Referring to FIG. 6, because the number of REs included in the NPBCH of one subframe is 100, the user device 100 of FIG. 1 may calculate 100 average values and measure NRSRP based on the 100 average values. Specifically, the user device 100 of FIG. 1 may measure NRSRP based on a value (mean square of an average value or an absolute value of the average value) corresponding to the 100 average values. However, the inventive concepts are not limited thereto, and the user device 100 of FIG. 1 may measure NRSRP based on all or part of a plurality of average values.

The user device 100 of FIG. 1 according to the inventive concepts may measure NRSRP according to Equation 1. Equation 1 may be understood through the examples described above. Equation 1 is an example to help understanding of the inventive concepts, and the inventive concepts are not limited thereto.

$${Y}_{n , k} = {H}_{n , k} {X}_{k} + {W}_{n , k} \qquad Equation 1$$

$$\hat{P} = \frac{1}{{N}_{RE}} {\sum }_{k = 0}^{{N}_{RE} - 1} {\vert \frac{1}{N} {\sum }_{n = 0}^{N - 1} {Y}_{n , k} \vert}^{2}$$

In Equation 1, \hat{P} is NRSRP, Y_{n,k} is the k^{th} data of an NPBCH received in the n^{th} frame (for example, n=1, that is, the first frame, referring to FIG. 6), H_{n,k} is a channel component of the data assigned to the k^{th} RE of the n^{th} frame, Xₖ is the k^{th} data descrambled after a scrambling sequence is generated, W_{n,k} is additive white gaussian noise (AWGN) with an average of 0 and variance σ² included in the k^{th} RE of the n^{th} frame, N_{RE} is the number of REs or the number of groups assigned to an NPBCH (for example, N_{RE} is 100 referring to FIG. 6), and N is an integer of 2 or greater and means the number of consecutive frames (for example, 8 referring to FIG. 4).

The user device 100 of FIG. 1 according to embodiments may measure NRSRP based on a differential correlation value of the received powers of two REs that are included in each of two consecutive descrambled NPBCHs and correspond to each other. The differential correlation value of corresponding REs means a conjugate product of the corresponding REs. Referring to FIG. 6, the number of REs included in the NPBCH of one subframe is 100, and accordingly, the user device 100 of FIG. 1 may calculate 100 differential correlation values based on two consecutive descrambled NPBCHs. The user device 100 of FIG. 1 may measure NRSRP based on 100 differential correlation values. For example, the user device 100 of FIG. 1 may measure the NRSRP based on any one of an average, a smallest value, a greatest value, and/or a median value of the 100 differential correlation values.

The user device 100 of FIG. 1 according to embodiments may measure NRSRP by calculating differential correlation values for N descrambled NPBCHs. The user device 100 of FIG. 1 may calculate (N−1)*K differential correlation values based on a differential correlation between N consecutive descrambled NPBCHs. Here, K is the number of REs included in an NPBCH of one subframe (for example, K=100, referring to FIG. 6), K is an integer of 100 or less, and N is an integer of 2 to 8 (N may mean the number of frames). There are N−1 pairs of two consecutive descrambled NPBCHs in N descrambled NPBCHs. Accordingly, the user device 100 of FIG. 1 may calculate (N−1)*K differential correlation values (e.g., with respect to each of the corresponding REs across the N−1 pairs of two consecutive descrambled NPBCHs). According to embodiments, the user device 100 may calculate a differential correlation value for two REs at a common position in the frequency-time domain across a pair of consecutive descrambled NPBCHs. The user device 100 may repeat this differential correlation value calculation with respect to each of the remaining 99 REs corresponding between the pair of consecutive descrambled NPBCHs. These differential correlation value calculations may also be performed with respect to each of the remaining pairs of consecutive descrambled NPBCHs among the N descrambled NPBCHs. The user device 100 of FIG. 1 may measure NRSRP based on any one of an average, a smallest value, a greatest value, and/or a median value of (N−1)*K differential correlation values. However, the inventive concepts are not limited thereto, and the user device 100 of FIG. 1 may measure the NRSRP based on all or part of a plurality of differential correlation values.

For example, referring to FIGS. 4 and 6, the user device 100 of FIG. 1 may receive eight (N=8) consecutive frames Frame_0 to Frame_7 in FIG. 4. Each first subframe of the eight frames Frame_0 to Frame_7 of FIG. 4 may include 100 (K=100) REs to which an NPBCH is assigned. The user device 100 of FIG. 1 may differentially correlate the received powers of corresponding REs included in two consecutive frames, that is, the first frame Frame_0 of FIG. 4 and the second frame Frame_1 of FIG. 4. Similarly, the user device 100 of FIG. 1 may differentially correlate the received powers of corresponding REs included respectively in the second frame Frame_1 of FIG. 4 and the third frame Frame_2 of FIG. 4), differentially correlate the received powers of corresponding REs included respectively in the third frame Frame_2 of FIG. 4 and the fourth frame Frame_3 of FIG. 4), differentially correlate the received powers of corresponding REs included respectively in the fourth frame Frame_3 of FIG. 4 and the fifth frame Frame_4 of FIG. 4), differentially correlate the received powers of corresponding REs included respectively in the fifth frame Frame_4 of FIG. 4 and the sixth frame Frame_5 of FIG. 4), differentially correlate the received powers of corresponding REs included respectively in the sixth frame Frame_5 of FIG. 4 and the seventh frame Frame_6 of FIG. 4), and differentially correlate the received powers of corresponding REs included respectively in the seventh frame Frame_6 of FIG. 4 and the eighth frame Frame_7 of FIG. 4). That is, the user device of FIG. 100 may perform differential correlation calculation for two descrambled NPBCHs seven times. Finally, the user device 100 of FIG. 1 may calculate 700 differential correlation values. The user device 100 of FIG. 1 may measure NRSRP based on the 700 differential correlation values.

For example, the user device 100 of FIG. 1 may measure the NRSRP based on an average of the 700 differential correlation values. Alternatively, the user device 100 of FIG. 1 may measure the NRSRP based on an average of 100 differential correlation values corresponding to two consecutive frames among the 700 differential correlation values. Accordingly, the user device 100 of FIG. 1 may calculate an averages of seven differential correlation values (to obtain seven averages), and measure the NRSRP based on any one of an average, a greatest value, a smallest value, and/or a median value of the seven differential correlation values (e.g., seven averages of differential correlation values). However, as described above, the inventive concepts are not limited thereto.

The user device 100 of FIG. 1 according to embodiments may calculate a first cumulative value corresponding to cumulative received powers of REs, that are included in a first frame group including at least two consecutive frames, and correspond to each other. The user device 100 of FIG. 1 may calculate a second cumulative value corresponding to cumulative received powers of REs, that are included in a second frame group including at least two consecutive frames, and correspond to each other. At least one of the at least two frames included in each of the first frame group and/or the second frame group may be different from each other. The user device 100 of FIG. 1 may measure NRSRP based on the first cumulative value and the second cumulative value.

Specifically, the user device 100 of FIG. 1 may descramble an NPBCH included in the first frame group (e.g., descramble an NPBCH of each frame included in the first frame group) to generate at least two first descrambled NPBCHs and may descramble an NPBCH included in the second frame group (e.g., descramble an NPBCH of each frame included in the second frame group) to generate at least two second descrambled NPBCHs. The user device 100 of FIG. 1 may measure NRSRP based on a first cumulative value corresponding to the cumulative received powers of REs that are included in each of at least two first descrambled NPBCHs and correspond to each other and a second cumulative value corresponding to the cumulative received powers of REs that are included in each of at least two second descrambled NPBCHs and correspond to each other. Here, the first or second cumulative value may mean the sum of received powers of corresponding REs. Alternatively, hereinafter, embodiments of the inventive concepts are described based on a cumulative value, but are not limited thereto. For example, the user device 100 of FIG. 1 according to the inventive concepts may measure NRSRP by using an average value instead of a cumulative value in an NRSRP measurement method to be described below. Specifically, the user device 100 of FIG. 1 may generate a first average value through the first cumulative value and may generate a second average value through the second cumulative value. The user device 100 of FIG. 1 may also measure the NRSRP based on the first average value and the second average value.

For example, referring to FIGS. 4 and 6, the user device 100 of FIG. 1 may receive eight consecutive frames Frame_0 to Frame_7 of FIG. 4. The first frame group may include the first to fourth frames Frame_0 to Frame_3. The second frame group may include the fifth to eighth frames Frame_4 to Frame_7. The user device 100 of FIG. 1 may descramble the NPBCH included in the first frame group to generate four first descrambled NPBCHs. The user device 100 of FIG. 1 may descramble the NPBCH included in the second frame group to generate four second descrambled NPBCHs. The user device 100 of FIG. 1 may generate the first cumulative value corresponding to cumulative REs that are included in each of the four first descrambled NPBCHs and correspond to each other. In addition, the user device 100 of FIG. 1 may generate the second cumulative value corresponding to cumulative REs that are included in each of the four second descrambled NPBCHs and correspond to each other. The user device 100 of FIG. 1 may measure NRSRP based on the first cumulative value and the second cumulative value.

In another example, referring to FIGS. 4 and 6, the user device 100 of FIG. 1 may receive eight consecutive frames Frame_0 to Frame_7 in FIG. 4. The first frame group may include the first frame Frame_0 and the second frame Frame_1. The second frame group may include the third frame Frame_2 and the fourth frame Frame_3. The third frame group may include the fifth frame and the sixth frame. The fourth frame group may include the seventh frame and the eighth frame. The user device 100 of FIG. 1 may measure NRSRP based on a first cumulative value derived from an NPBCH included in the first frame group, a second cumulative value derived from an NPBCH included in the second frame group, a third cumulative value derived from an NPBCH included in the third frame group, and a fourth cumulative value derived from an NPBCH included in the fourth frame group.

The examples described above are intended to aid understanding of the inventive concepts but the inventive concepts are not limited thereto. In embodiments, the number of frame groups, and the number of frames included in each frame group, may be different from the examples described above.

Subsequently, the user device 100 of FIG. 1 may measure NRSRP based on a differential correlation between the first cumulative value and the second cumulative value derived from two frame groups. For example, referring to the example described above, the user device 100 of FIG. 1 may measure NRSRP based on the differential correlation between the first cumulative value and the second cumulative value respectively derived from the first and second frame groups, each including four frames. In addition, referring to another example described above, NRSRP may be measured by using the differential correlation between the first cumulative value and the second cumulative value respectively derived from the first frame group and the second frame group, each including two frames, and the differential correlation between the third cumulative value and the fourth cumulative value respectively derived from the third frame group and the fourth frame group, each including two frames.

As described above, referring to FIG. 6, the number of REs included in the NPBCH of one subframe is 100, and accordingly, the user device 100 of FIG. 1 may calculate 100 cumulative values. According to embodiments, the user device 100 may calculate a single cumulative value for REs at a common position in the frequency-time domain across each NPBCH included in a respective frame group (e.g., by summing the values for the REs), and may repeat this calculation with respect to each of the remaining 99 REs corresponding between the NPBCHs in the frame group, to obtain 100 cumulative values for the respective frame group. That is, the user device 100 may generate 100 first cumulative values and 100 second cumulative values from each frame group (e.g., respectively corresponding to the first frame group and the second frame group). The user device 100 of FIG. 1 may measure NRSRP by using differential correlations between the 100 first cumulative values and the 100 second cumulative values. Referring to another example described above, the user device 100 of FIG. 1 may measure NRSRP by using the differential correlations between the 100 first cumulative values and the 100 second cumulative values, and differential correlations between 100 third cumulative values and 100 fourth cumulative values. According to embodiments, rather than calculating cumulative values, the user device 100 may calculate a single average value for REs at a common position in the frequency-time domain across each NPBCH included in a respective frame group (e.g., by summing the values for the REs and dividing the result by the number of frames in the respective frame group), and may repeat this calculation with respect to each of the remaining 99 REs corresponding between the NPBCHs in the frame group, to obtain 100 average values for the respective frame group. The user device 100 of FIG. 1 may measure NRSRP by using differential correlations between the 100 first average values (of the first frame group) and the 100 second average values (of the second frame group), for example.

The user device 100 of FIG. 1 according to the inventive concepts may measure NRSRP according to Equation 2. Equation 2 may be understood through the examples described above. Equation 2 is an example to help understand the inventive concepts, and the inventive concepts are not limited thereto.

$$\hat{P} = \frac{1}{{N}_{RE}} {\sum }_{k = 0}^{{N}_{RE} - 1} ( \frac{1}{( \frac{N}{T} - 1 )} {\sum }_{m = 0}^{\frac{N}{T} - 2} {Y}_{m , k} \cdot {Y}_{m + 1 , k}^{*} ) = \frac{1}{{N}_{RE}} {\sum }_{k = 0}^{{N}_{RE} - 1} \frac{1}{( \frac{N}{T} - 1 )} {\sum }_{m = 0}^{\frac{N}{T} - 2} ( {H}_{m , k} {X}_{k} + {W}_{m , k} ) \cdot {( {H}_{m + 1 , k} {X}_{k} + {W}_{m + 1 , k} )}^{*} = \frac{1}{{N}_{RE} ( \frac{N}{T} - 1 )} {\sum }_{k = 0}^{{N}_{RE} - 1} {\sum }_{m = 0}^{\frac{N}{T} - 2} ( {H}_{m , k} {X}_{k} {X}_{k} * {H}_{m + 1 , k} + W ) \qquad Equation 2$$

Among factors of Equation 2, the same factors as (or similar factors to) the factors represented in Equation 1 are not described. In Equation 2, T is the number of frames included in a frame group, Y_{m,k} is cumulative k^{th} REs of each of T frames included in the m^{th} frame group.

The user device 100 of FIG. 1 according to the inventive concepts may measure NRSRP by using another method depending on channel environments. For example, the user device 100 of FIG. 1 may measure NRSRP (for example, according to Equation 1) based on an average value of the received powers of corresponding REs in a channel environment with relatively little change. In addition, in a relatively variable channel environment, the NRSRP may be measured (for example, according to Equation 2) based on either differential correlation values of the received powers of corresponding REs or a differential correlation between at least two cumulative values.

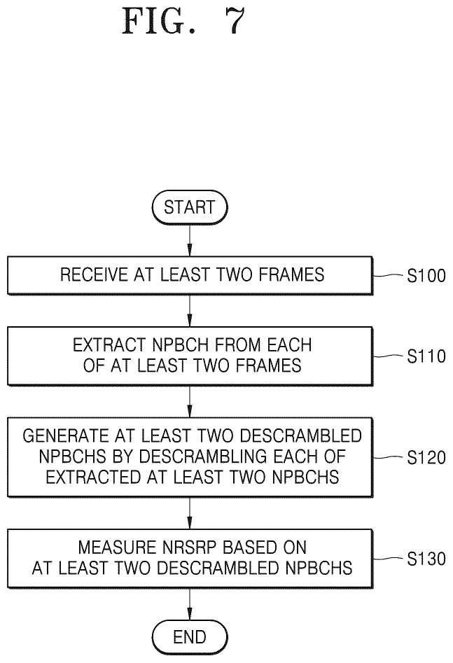

FIG. 7 is a flowchart illustrating an operating method of a user device, according to embodiments.

Referring to FIG. 7, in operation S100, the user device 100 of FIG. 1 may receive at least two frames. For example, the user device 100 of FIG. 1 may receive two to eight consecutive frames from either the serving cell 20 of FIG. 1 or the neighboring cell 30 of FIG. 1.

In operation S110, the user device 100 of FIG. 1 may extract an NPBCH from each of at least two frames. For example, the user device 100 of FIG. 1 may extract the NPBCH from each of a plurality of frames received from either the serving cell 20 of FIG. 1 or the neighboring cell 30 of FIG. 1. As described above, the NPBCH may be in the first subframe included in each frame.

In operation S120, the user device 100 of FIG. 1 may descramble each of the at least two extracted NPBCHs to generate at least two descrambled NPBCHs.

In operation S130, the user device 100 of FIG. 1 may measure NRSRP based on the at least two descrambled NPBCHs. For example, the user device 100 of FIG. 1 may measure the NRSRP based on any one of an average value of the received powers of corresponding REs included in the NPBCH, a differential correlation between the received powers, and/or a differential correlation between cumulative values of the received powers.

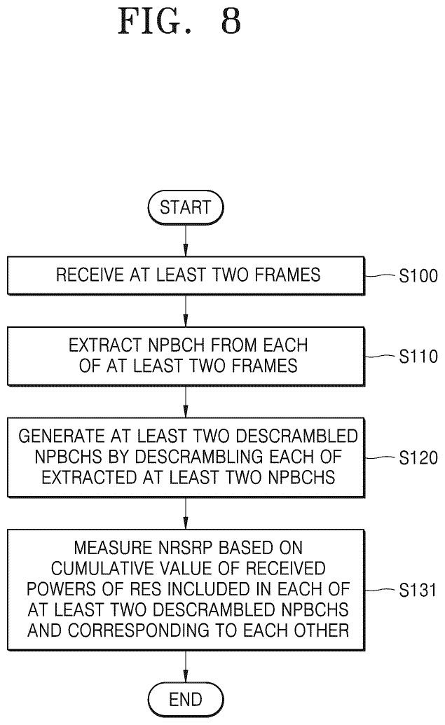

FIG. 8 is a flowchart illustrating an operating method of a user device, according to embodiments.

Operation S100, operation S110, and operation S120 of FIG. 8 overlap the descriptions given with reference to FIG. 7, and accordingly, detailed descriptions thereof are omitted. Hereinafter, description is focused on operation S131 with reference to FIG. 8, and operation S131 describes in more detail operation S130 of FIG. 7.

Referring to FIG. 8, in operation S131, the user device 100 of FIG. 1 may measure NRSRP based on a cumulative value of the received powers of REs that are included in each of at least two descrambled NPBCHs and correspond to each other. Here, the user device 100 of FIG. 1 may calculate an average value based on the cumulative value of received powers of corresponding REs. The user device 100 of FIG. 1 may measure the NRSRP based on the average value as described above.

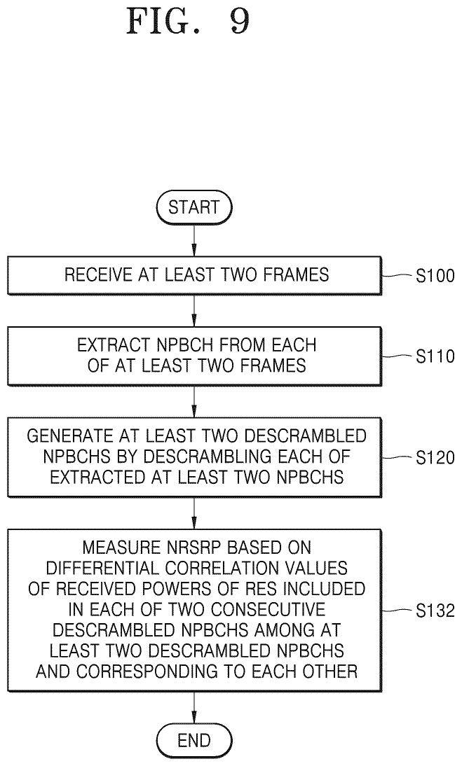

FIG. 9 is a flowchart illustrating an operating method of a user device, according to embodiments.

Operation S100, operation S110, and operation S120 of FIG. 9 overlap the descriptions with reference to FIG. 7, and accordingly, detailed descriptions thereof are omitted. Hereinafter, description is focused on operation S132 with reference to FIG. 9, and operation S132 describes in more detail operation S130 of FIG. 7.

Referring to FIG. 9, in operation S132, the user device 100 of FIG. 1 may measure NRSRP based on a differential correlation value of the received powers of REs, that are included in each of two consecutive descrambled NPBCHs among at least two descrambled NPBCHs, and correspond to each other. For example, the user device 100 of FIG. 1 may receive N frames and derive descrambled NPBCHs from each of the N frames. The user device 100 of FIG. 1 may calculate a differential correlation between the received powers of REs, that are included in each of two consecutive descrambled NPBCHs among the N descrambled NPBCHs, and correspond to each other. When each of the N descrambled NPBCHs includes K REs, the user device 100 of FIG. 1 may calculate (N−1)*K differential correlation values. The user device 100 of FIG. 1 may measure NRSRP based on the (N−1)*K differential correlation values.

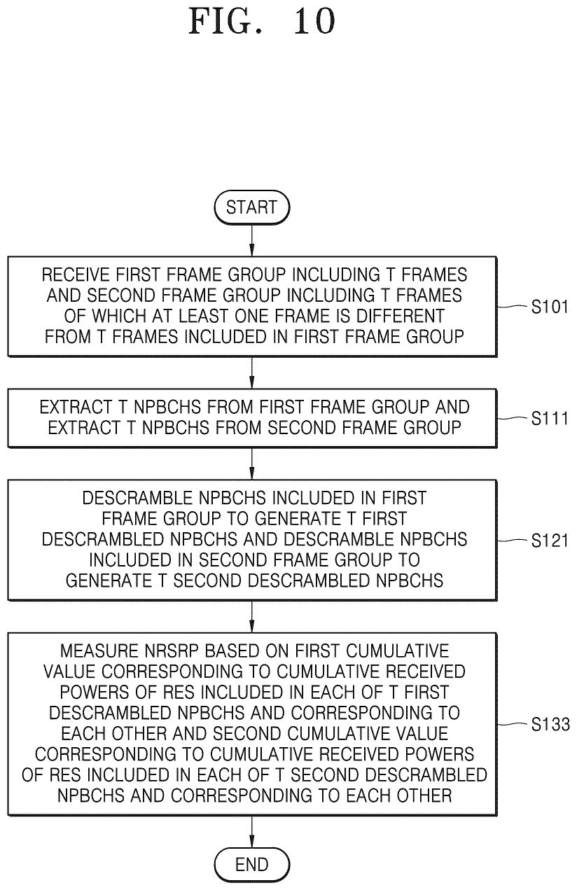

FIG. 10 is a flowchart illustrating an operating method of a user device, according to embodiments.

Operation S101, operation S111, operation S121, and operation S133 of FIG. 10 describe in more detail the operations described with reference to FIG. 7. Therefore, the descriptions given with reference to FIG. 7 are omitted in describing FIG. 10.

Referring to FIG. 10, in operation S101, the user device 100 of FIG. 1 may receive a first frame group including T frames, and a second frame group including T frames of which at least one frame is different from the T frames included in the first frame group. T may mean the number of frames included in one frame group. T is an integer of 2 or greater.

In operation S111, the user device 100 of FIG. 1 may extract T NPBCHs from the first frame group and extract T NPBCHs from the second frame group.

In operation S121, the user device 100 of FIG. 1 may descramble NPBCHs included in the first frame group to generate T first descrambled NPBCHs and may descramble NPBCHs included in the second frame group to generate T second descrambled NPBCHs.

In operation S133, the user device 100 of FIG. 1 may measure NRSRP based on a first cumulative value corresponding to the cumulative received powers of REs that are included in each of the T first descrambled NPBCHs and correspond to each other, and a second cumulative value corresponding to the cumulative received powers of REs that are included in each of the T second descrambled NPBCHs and correspond to each other. For example, when there are 100 REs included in one NPBCH, the number of the first and second cumulative values may each be 100. The user device 100 of FIG. 1 may measure the NRSRP by using differential correlations between 100 first cumulative values and 100 second cumulative values.

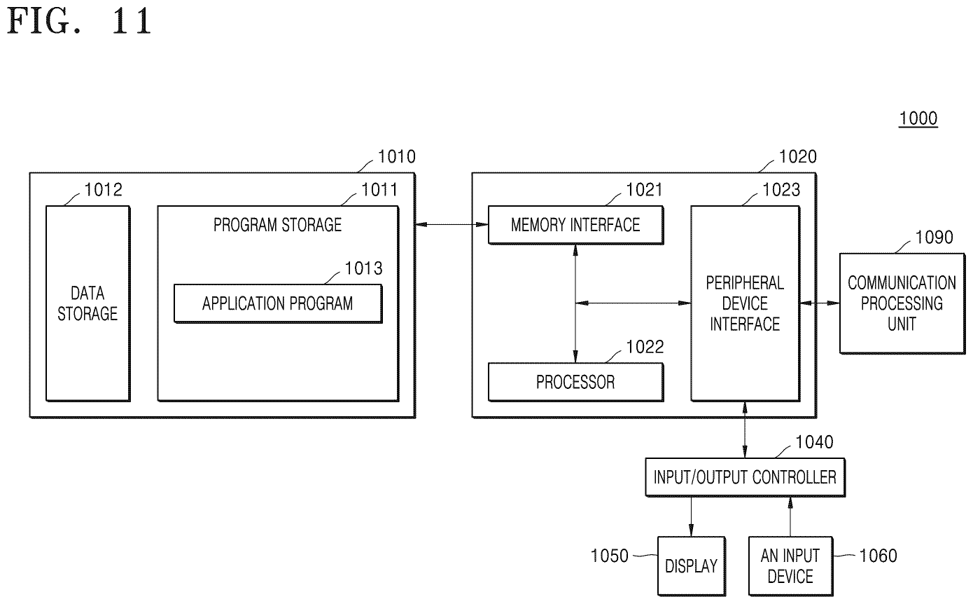

FIG. 11 is a schematic block diagram illustrating an electronic device according to embodiments. An electronic device 1000 of FIG. 11 may be a user device according to embodiments.

Referring to FIG. 11, the electronic device 1000 may include a memory 1010, a processor unit 1020, an input/output controller 1040, a display 1050, an input device 1060, and/or a communication processing unit 1090. Here, the memory 1010 may be plural. The respective components are described in detail below.

The memory 1010 may include a program storage 1011 that stores a program for controlling an operation of the electronic device 1000 and a data storage 1012 that stores data generated during execution of the program. The data storage 1012 may store data used for an operation of an application program 1013 and a core set decoding program, or may store data generated from the operation of the application program 1013. For example, the data storage 1012 may store an NPBCH descrambled by a processor 1022. The data storage 1012 may output the descrambled NPBCH to the processor unit 1020 under control by the processor unit 1020.

The program storage 1011 may store the application program 1013. The program stored in the program storage 1011 may be a set of instructions and may also be referred to as an instruction set. The application program 1013 may include program codes for various applications performed by the electronic device 1000. That is, the application program 1013 may include codes (or commands) for various applications driven by the processor 1022.

The processor 1022 according to the inventive concepts may descramble at least two received NPBCHs. The processor 1022 may first store the descrambled NPBCH in the data storage 1012 to measure NRSRP based on at least two descrambled NPBCHs.

In addition, the electronic device 1000 may include the communication processing unit 1090 that performs a communication function for voice communication and data communication. A peripheral device interface 1023 may control connections between the input/output controller 1040, the communication processing unit 1090, a processor 1022, and/or a memory interface 1021. The processor 1022 controls a plurality of base stations to provide a corresponding service by using at least one software program. In this case, the processor 1022 may execute at least one program stored in the memory 1010 to provide a service corresponding to the corresponding program.

The input/output controller 1040 may provide an interface between an input/output device, such as the display 1050 and/or the input device 1060, and the peripheral device interface 1023. The display 1050 displays state information, input texts, moving pictures, and still pictures. For example, the display 1050 may display application program information driven by the processor 1022.

The input device 1060 may provide input data generated by selection of an electronic device to the processor unit 1020 through the input/output controller 1040. In this case, the input device 1060 may include a keypad including at least one hardware button, a touchpad that senses touch information, and so on. For example, the input device 1060 may provide touch information, such as touch, touch movement, and touch release detected through the touchpad to the processor 1022 through the input/output controller 1040.

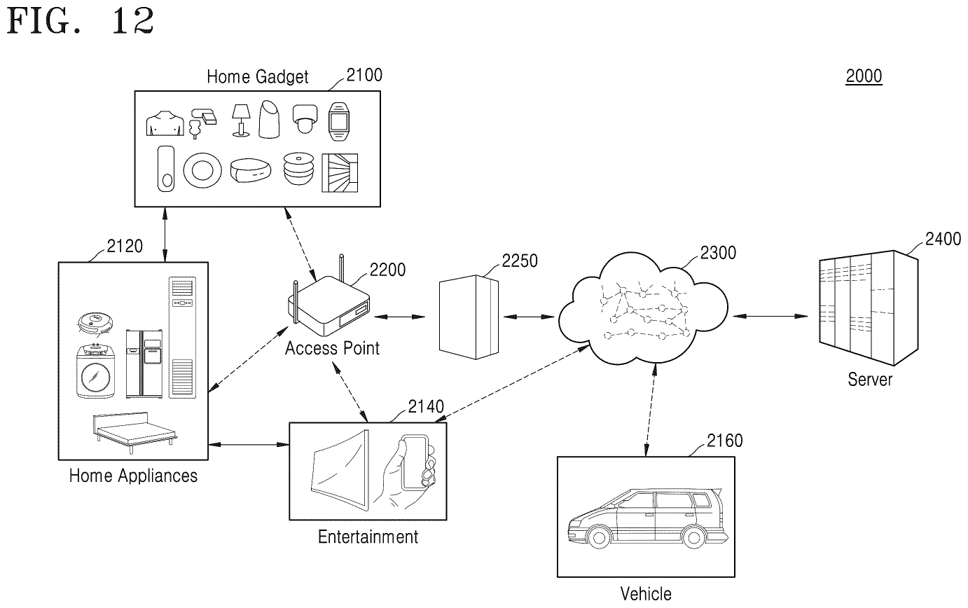

FIG. 12 is a conceptual diagram illustrating an IoT network system to which embodiments of the inventive concepts are applied.

Referring to FIG. 12, an Internet of Things (IoT) network system 2000 may include a plurality of IoT devices 2100, 2120, 2140, and/or 2160, an access point 2200, a gateway 2250, a wireless network 2300, and/or a server 2400. The IoT may refer to a network between things using wired/wireless communication.

The plurality of IoT device 2100, 2120, 2140, and 2160 may each form a group according to characteristics of each IoT device. For example, the plurality of IoT devices may be grouped into a home gadget group 2100, a home appliance/furniture group 2120, an entertainment group 2140, and/or a vehicle group 2160. The plurality of IoT devices 2100, 2120, and 2140 may be connected to a communication network or to other IoT devices through the access point 2200. The access point 2200 may be built into one IoT device. The gateway 2250 may change a protocol to connect the access point 2200 to an external wireless network. The plurality of IoT devices 2100, 2120, and 2140 may be connected to an external communication network through the gateway 2250. The wireless network 2300 may include the Internet and/or a public network. The plurality of IoT devices 2100, 2120, 2140, and 2160 may be connected to the server 2400 that provides a certain service through the wireless network 2300, and users may use the service through at least one of the plurality of IoT devices 2100, 2120, 2140, and 2160.

According to embodiments of the inventive concepts, the plurality of IoT devices 2100, 2120, 2140, and 2160 may perform narrowband IoT communication. The plurality of IoT devices 2100, 2120, 2140, and 2160 may receive at least two NPBCHs and measure NRSRP based on the at least two NPBCHs. The plurality of IoT devices 2100, 2120, 2140, and 2160 according to the inventive concepts may measure NRSRP without decoding the at least two received NPBCHs (e.g., by performing the operations discussed in connection with FIGS. 7-10). Therefore, even when decoding fails, NRSRP may be measured, and thus, the time consumed to measure NRSRP may be reduced.

Conventional devices and methods for measuring narrowband reference signal received power (NRSRP) of a narrowband physical broadcast channel (NPBCH) received from a base station measure the NRSRP of the NPBCH after successfully decoding the NPBCH. The measurement of the NRSRP using the decoded NPBCH involves storing the decoded NPBCH in a memory, regenerating the NPBCH by encoding, scrambling and modulating the NPBCH according to a decoding rule, and measuring the NRSRP using the regenerated NPBCH. Accordingly, the NRSRP measurement of the NPBCH performed by the conventional devices and methods consumes excessive amounts of resources (e.g., delay, processor, memory, power, etc.).

However, according to embodiments, improved devices and methods are provided for measuring NRSRP of a NPBCH received from a base station. For example, the improved devices and methods measure the NRSRP based on at least two NPBCHs included in at least two frames without decoding the at least two NPBCHs. In so doing, the improved devices and methods utilize repetitive characteristics of the at least two NPBCHs to measure the NRSRP. Accordingly, the improved devices and methods overcome the deficiencies of the conventional devices and methods to at least measure the NRSRP of the NPBCH without decoding the NPBCH, thereby reducing resource consumption (e.g., delay, processor, memory, power, etc.).

According to embodiments, operations described herein as being performed by the wireless communication system 10, the serving cell 20, the user device 100, the neighboring cell 30, the transceiver 110, the processor 120, the NRSRP measurement circuit 122, the electronic device 1000, the processor unit 1020, the input/output controller 1040, the communication processing unit 1090, the peripheral device interface 1023, the processor 1022, the memory interface 1021, the IoT network system 2000, each of plurality of IoT devices 2100, 2120, 2140 and/or 2160, the access point 2200, the gateway 2250 and/or the server 2400 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 130 and/or the memory 1010). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

According to embodiments, operations discussed herein in connection with a given figure may be combined with operations discussed in connection with one or more other figures.

Embodiments may be described with reference to acts and symbolic representations of operations (e.g., in the form of flow charts, flow diagrams, data flow diagrams, structure diagrams, block diagrams, etc.) that may be implemented in conjunction with units, circuits and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

It will be understood that when an element is referred to as being “connected” or “coupled” to another element, it may be directly connected or coupled to the other element or intervening elements may be present. As used herein the term “and/or” includes any and all combinations of one or more of the associated listed items.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

As described above, embodiments are disclosed in the drawings and specification. In the inventive concepts, embodiments are described with specific terms, but this is only for the purpose of describing the technical idea of the inventive concepts and is not intended to limit the meaning or scope of the inventive concepts described in the claims. Therefore, those skilled in the art will understand that various modifications and other equivalent examples may be derived therefrom. Therefore, the true technical protection scope of the inventive concepts should be determined by the technical idea of the attached claims.

While the inventive concepts have been particularly shown and described with reference to embodiments thereof, it will be understood that various changes in form and details may be made therein without departing from the spirit and scope of the following claims.

What is claimed is:

1. A user device for performing narrowband Internet of Things-based communication, the user device comprising:
processing circuitry configured to
descramble narrowband physical broadcast channels (NPBCHs) respectively included in at least two frames to obtain at least two descrambled NPBCHs, the NPBCHs including identical data and having different phases from each other, and
measure narrowband reference signal received power (NRSRP) based on the at least two descrambled NPBCHs.

2. The user device of claim 1, wherein the processing circuitry is configured to measure the NRSRP based on an average value of received power of first resource elements (REs), the first REs being included in each of the at least two descrambled NPBCHs, and the first REs corresponding to each other.

3. The user device of claim 2, wherein
each of the at least two descrambled NPBCHs includes K REs, K being an integer of 100 or less; and
the processing circuitry is configured to
generate K average values of received power based on the first REs, and
measure the NRSRP based on each of the K average values of received power.

4. The user device of claim 1, wherein the processing circuitry is configured to measure the NRSRP based on a differential correlation value of two REs, the two REs being included in each of two consecutive descrambled NPBCHs among the at least two descrambled NPBCHs, and the two REs corresponding to each other.

5. The user device of claim 4, wherein
each of the two consecutive descrambled NPBCHs includes K REs, K being an integer of 100 or less); and
the processing circuitry is configured to
generate K differential correlation values based on second REs, the second REs being included in each of the two consecutive descrambled NPBCHs, and the second REs corresponding to each other, and
measure the NRSRP based on an average of the K differential correlation values.

6. The user device of claim 1, wherein the processing circuitry is
configured to:
generate T first descrambled NPBCHs by descrambling NPBCHs included in a first frame group, T being an integer of 2 or greater;
generate T second descrambled NPBCHs by descrambling NPBCHs included in a second frame group, each of the first frame group and the second frame group including T frames; and
measure the NRSRP based on a first cumulative value and a second cumulative value, the first cumulative value being generated based on cumulative received powers of third REs, the third REs being included in each of the T first descrambled NPBCHs, the third REs corresponding to each other, the second cumulative value being generated based on cumulative received powers of fourth REs, the fourth REs being included in each of the T second descrambled NPBCHs, and the fourth REs corresponding to each other.

7. The user device of claim 6, wherein
each of the third REs and the fourth REs includes K REs, K being an integer of 100 or less; and
the processing circuitry is configured to
generate K first cumulative values based on the third REs,
generate K second cumulative values based on the fourth REs, and
measure the NRSRP based on a differential correlation between the K first cumulative values and the K second cumulative values.

8. The user device of claim 6, wherein the processing circuitry is configured to
generate K first cumulative values based on the third REs,
generate K second cumulative values based on the fourth REs, and
measure the NRSRP based on a differential correlation between K first average values and K second average values, the K first average values being obtained by dividing each of the K first cumulative values by T, and the K second average values being obtained by dividing each of the K second cumulative values by T.

9. The user device of claim 1, wherein
the at least two frames are received from a neighboring cell; and
the processing circuitry is configured to request a serving cell for a handover to the neighboring cell based on the NRSRP.

10. An operating method of a user device for performing narrowband Internet of Things-based communication, the operating method comprising:
extracting narrowband physical broadcast channels (NPBCHs) from at least two frames to obtain extracted NPBCHs, the NPBCHs including identical data and having different phases from each other;
generating at least two descrambled NPBCHs by descrambling the extracted NPBCHs; and
measuring narrowband reference signal received power (NRSRP) based on the at least two descrambled NPBCHs.

11. The operating method of claim 10, further comprising:
storing the at least two descrambled NPBCHs in a memory.

12. The operating method of claim 10, wherein the measuring of the NRSRP comprises:
measuring the NRSRP based on cumulative values of received powers of first resource elements (REs), the first REs being included in each of the at least two descrambled NPBCHs, and the first REs corresponding to each other.

13. The operating method of claim 12, wherein
each of the at least two descrambled NPBCHs includes K REs, K being an integer of 100 or less; and
the measuring of the NRSRP comprises:
generating K cumulative values based on the first REs, and
measuring the NRSRP based on each of the K cumulative values.

14. The operating method of claim 10, wherein the measuring of the NRSRP comprises measuring the NRSRP based on differential correlation values of received powers of second REs, the second REs being included in each of two consecutive descrambled NPBCHs among the at least two descrambled NPBCHs, and the second REs corresponding to each other.

15. The operating method of claim 14, wherein
the at least two frames include N consecutive frames, N being an integer of 2 or greater;
the at least two descrambled NPBCHs include N descrambled NPBCHs;
each of the N descrambled NPBCHs includes K resource elements, K being an integer of 100 or less; and
the measuring of the NRSRP comprises
generating (N−1)*K differential correlation values based on the second REs, and
measuring the NRSRP based on the (N−1)*K differential correlation values.

16. The operating method of claim 10, wherein
the at least two frames includes a first frame group and a second frame group, each of the first frame group and the second frame group including T frames, T being an integer of 2 or greater, and the second frame group including at least one frame is different from the T frames included in the first frame group;
the extracting of the NPBCHs from the at least two frames includes
extracting T NPBCHs from the first frame group to obtain first extracted T NPBCHs, and
extracting T NPBCHs from the second frame group to obtain second extracted T NPBCHs;
the generating of the at least two descrambled NPBCHs includes
generating T first descrambled NPBCHs by descrambling the first extracted T NPBCHs, and
generating T second descrambled NPBCHs by descrambling the second extracted T NPBCHs; and
the measuring of the NRSRP includes
measuring the NRSRP based on a first cumulative value and a second cumulative value, the first cumulative value corresponding to cumulative received powers of third REs, the third REs being included in each of the T first descrambled NPBCHs, the third REs corresponding to each other, the second cumulative value corresponding to cumulative received powers of fourth REs, the fourth REs being included in each of the T second descrambled NPBCHs, and the fourth REs corresponding to each other.

17. The operating method of claim 10, wherein the at least two frames includes eight frames.

18. A user device for performing narrowband Internet of Things-based communication, the user device comprising:
processing circuitry configured to
measure first narrowband reference signal received power (NRSRP) based on at least two first narrowband physical broadcast channels (NPBCHs), the at least two first NPBCHs being included in each of at least two frames among at least N consecutive frames received from a first cell, N being an integer of 2 or greater, the first cell being connected to the user device, and the at least two first NPBCHs including identical data and having different phases from each other,
measure a second NRSRP based on at least two second NPBCHs included in each of at least two frames among at least N consecutive frames received from a second cell, the second cell being different from the first cell, and the at least two second NPBCHs including identical data and having different phases from each other, and
determine whether to request a handover based on the first NRSRP and the second NRSRP.

19. The user device of claim 18, wherein the processing circuitry is configured to:
measure the first NRSRP based on an average value of received powers of first resource elements (REs), the first REs being included in each of the at least two first NPBCHs, and the first REs corresponding to each other; and
measure the second NRSRP based on an average value of received powers of second resource elements (REs), the second REs being included in each of the at least two second NPBCHs, and the second REs corresponding to each other.

20. The user device of claim 18, wherein the processing circuitry is configured to:
measure the first NRSRP based on a differential correlation value of received powers of two third REs, the two third REs being included in each of two consecutive descrambled NPBCHs among the at least two first NPBCHs, and the two third REs corresponding to each other; and
measure the second NRSRP based on a differential correlation value of received powers of two fourth REs, the two fourth REs being included in each of two consecutive descrambled NPBCHs among the at least two second NPBCHs, and the two fourth REs corresponding to each other.
